(19) United States
(12) Patent Application Publication
(10) Pub. No.: US 2025/0103645 A1
(43) Pub. Date: Mar. 27, 2025

(54) SCANNING FOR SUSPICIOUS FIRST-GENERATION DIGITAL CONTENT

(71) Applicant: NETSPARK LTD., GIVA'T SHMU'EL (IL)

(72) Inventors: Elyasaf Korenwaitz, Elon-More (IL); Zvi Bazak, Jerusalem (IL); Ariel Yosef, Rehovot (IL)

(73) Assignee: NETSPARK LTD., GIVA'T SHMU'EL (IL)

(21) Appl. No.: 18/574,329

(22) PCT Filed: Dec. 26, 2023
(86) PCT No.: PCT/IL2023/051314

§ 371 Date: Dec. 27, 2023

Related U.S. Application Data
(60) Provisional application No. 63/450,974, filed on Mar. 9, 2023.

(51) Int. Cl. G06F 16/583; G06F 16/55; G06F 16/783

(52) U.S. Cl. CPC G06F 16/583; G06F 16/55; G06F 16/784

(57) ABSTRACT

A system and method for identifying suspicious content and illegal activity and, more particularly, but not exclusively, to a system to identify first-generation child pornography on impounded data.

### RELATED APPLICATION/S

This application claims the benefit of priority under 35 USC § 119 (e) of U.S. Provisional Patent Application No. 63/450,974 filed Mar. 9, 2023, the contents of which are incorporated herein by reference in their entirety.

### SUMMARY OF THE INVENTION

According to an aspect of some embodiments of the invention, there is provided a method of analyzing electronic storage media for criminal activity including: classifying material according to a relationship to a user of the electronic storage media; and filtering material to identify illicit content.

According to some embodiments of the invention, the classifying includes differentiating between first generation content and non-first-generation content.

According to some embodiments of the invention, the method further includes analyzing a relationship between an illicit material and a non-illicit material.

According to some embodiments of the invention, the relationship includes an overlap between the illicit material and the non-illicit material.

According to some embodiments of the invention, the overlap includes a shared person, a shared object, a shared location, a shared time, a shared sound and a shared mannerism.

According to some embodiments of the invention, the relationship includes a difference between the illicit material and the non-illicit material.

According to some embodiments of the invention, the difference includes a change in a person and a reference to a person by a different name.

According to an aspect of some embodiments of the invention, there is provided a method of identifying illicit material in including: testing data in a digital storage media first-generation material; and scanning the first-generation material for illicit content.

According to some embodiments of the invention, the scanning includes content analysis.

According to some embodiments of the invention, the scanning identifies pornographic material.

According to some embodiments of the invention, the scanning identifies pedophilia.

According to some embodiments of the invention, the scanning includes tracking of an actor in the first-generation material.

According to some embodiments of the invention, the actor is identified across different digital media objects.

According to some embodiments of the invention, the actor is analyzed to estimate at least one of an age and a physical condition.

According to some embodiments of the invention, a physical condition of an actor is associated with actions depicted in the digital media objects.

According to some embodiments of the invention, the testing for first-generation includes analyzing at least one of a size of a file, metadata associated with the file, a location of the file, and editing of an image in the file.

According to an aspect of some embodiments of the invention, there is provided a system for identifying illicit material including: a processor; a digital memory including digital media readable by the processor; and a digital memory readable by the processor and including instructions for the processor to perform: scanning the digital memory for illicit content; and testing the illicit content for first-generation material.

According to an aspect of some embodiments of the invention, there is provided a system for identifying illicit material including: a processor; a digital memory including digital media readable by the processor; and a digital memory readable by the processor and including instructions for the processor to perform: testing data in the digital memory for first-generation material; and scanning the first-generation material for illicit content.

According to some embodiments of the invention, the scanning includes content analysis.

According to some embodiments of the invention, the scanning identifies pornographic material.

According to some embodiments of the invention, the scanning identifies pedophilia.

According to some embodiments of the invention, the scanning includes tracking of an actor in the first-generation material.

According to some embodiments of the invention, the actor is identified across different digital media objects.

According to some embodiments of the invention, the actor is analyzed to estimate at least one of an age and a physical condition.

According to some embodiments of the invention, a physical condition of an actor is associated with actions depicted in the digital media objects.

According to some embodiments of the invention, the testing for first-generation includes analyzing at least one of a size of a file, metadata associated with the file, a location of the file, and editing of an image in the file.

According to some embodiments of the invention, the system further includes at least one of a write blocker, a forensic bridge, and a password recovery device.

### FIELD AND BACKGROUND OF THE INVENTION

The present invention, in some embodiments thereof, relates to a system and method for identifying suspicious content and illegal activity and, more particularly, but not exclusively, to a system to identify child pornography on impounded data.

Individuals who engage in illegal activities related to child pornography may be divided between Aggressor-producer pedophiles and Collector pedophiles.

Aggressor-producer pedophiles may be defined as individuals who actively create, produce, and distribute child pornography. They may use a variety of methods, including grooming children online or in-person, coercing children into taking explicit photographs or videos, or filming themselves engaging in sexual acts with children.

Collector pedophiles, on the other hand, are individuals who primarily consume or collect child pornography. They may obtain these materials through various means, including downloading them from the internet or purchasing them from other collectors.

While both types of individuals engage in illegal activities, aggressor-producer pedophiles are generally considered more dangerous as they are directly involved in the sexual exploitation of children.

The current inventor has long been active in innovative methods to detect illicit content. For example, International Patent Application No. PCT/IL2022/051387 is entitled “Integrating textual and graphical analysis to detect internet human trafficking”. U.S. Pat. Nos. 11,574,476 and 11,468,679 are entitled “On-line video filtering”, International Patent Application Publication No. WO 2021240500 A1 entitled “Real time local filtering of on-screen images”, and U.S. Pat. No. 9,805,280 entitled “Image analysis systems and methods”.

Some relevant art includes, for example:

U.S. Pat. No. 9,269,243 B2 entitled “Method and user interface for forensic video search”;
JP Patent Publication No. 2017511674 entitled “System for identifying a photo camera model associated with a JPEG compressed image, and associated methods, uses and applications”;
U.S. Pat. No. 10,360,668 B1 entitled “Methods for requesting and authenticating photographic image data”;
US Patent Publication No. 20150213324 entitled “Photo forensics using image signatures”;
U.S. Pat. No. 9,734,870 B2 entitled “Media identifier generation for camera-captured media”;
US Patent Publication No. 20210168150 entitled “Systems and Methods for Understanding Identity and Organizational Access to Applications within an Enterprise Environment”;
U.S. Pat. No. 10,769,503 B1 entitled “Digital organization of printed documents according to extracted semantic information”;
U.S. Pat. No. 9,665,789 B2 entitled “Device and method for analyzing the correlation between an image and another image or between an image and a video”;
US Patent Publication No. 20210209388 entitled “Fakecatcher: detection of synthetic portrait videos using biological signals”;
U.S. Pat. No. 11,394,552 entitled “Systems and methods for privacy-enabled biometric processing”;
US Patent Publication No. 20210011986 entitled “Method to verify identity using a previously collected biometric image/data”; and
U.S. Pat. No. 9,860,208 entitled “Bridging a virtual clone of a target device in a honey network to a suspicious device in an enterprise network”.

However, there is still a need for a system and method for identifying suspicious content and illegal activity.

### SUMMARY OF THE INVENTION

According to an aspect of some embodiments of the invention, there is provided a method of analyzing an electronic storage media for criminal activity including: classifying material according to a relationship to a user of the electronic storage media; and filtering material to identify illicit content.

According to some embodiments of the invention, the classifying includes differentiating between first generation content and non-first-generation content.

According to some embodiments of the invention, the method further includes analyzing a relationship between an illicit material and a non-illicit material.

According to some embodiments of the invention, the relationship includes an overlap between the illicit material and the non-illicit material.

According to some embodiments of the invention, the overlap includes a shared person, a shared object, a shared location, a shared time, a shared sound and a shared mannerism.

According to some embodiments of the invention, the relationship includes a difference between the illicit material and the non-illicit material.

According to some embodiments of the invention, the difference includes a change in a person and a reference to a person by a different name.

According to an aspect of some embodiments of the invention, there is provided a method of identifying illicit material in including: testing data in a digital storage media for first-generation material; and scanning the first-generation material for illicit content.

According to some embodiments of the invention, the scanning includes content analysis.

According to some embodiments of the invention, the scanning identifies pornographic material.

According to some embodiments of the invention, the scanning identifies pedophilia.

According to some embodiments of the invention, the scanning includes tracking of an actor in the first-generation material.

According to some embodiments of the invention, the actor is identified across different digital media objects.

According to some embodiments of the invention, the actor is analyzed to estimate at least one of an age and a physical condition.

According to some embodiments of the invention, a physical condition of an actor is associated with actions depicted in the digital media objects.

According to some embodiments of the invention, the testing for first-generation includes analyzing at least one of a size of a file, metadata associated with the file, a location of the file, and editing of an image in the file.

According to some embodiments of the invention, the metadata associated with the file includes EXIF location and/or EXIF device type data.

According to some embodiments of the invention, the method further includes rating a likelihood that an item is first generation.

According to an aspect of some embodiments of the invention, there is provided a system for identifying illicit material including: a processor; a digital memory including digital media readable by the processor; and a digital memory readable by the processor and including instructions for the processor to perform: scanning the digital memory for illicit content; and testing the illicit content for first-generation material.

According to an aspect of some embodiments of the invention, there is provided a system for identifying illicit material including: a processor; a digital memory including digital media readable by the processor; and a digital memory readable by the processor and including instructions for the processor to perform: testing data in the digital memory for first-generation material; and scanning the first-generation material for illicit content.

According to some embodiments of the invention, the scanning includes content analysis.

According to some embodiments of the invention, the scanning identifies pornographic material.

According to some embodiments of the invention, the scanning identifies pedophilia.

According to some embodiments of the invention, the scanning includes tracking of an actor in the first-generation material.

According to some embodiments of the invention, the actor is identified across different digital media objects.

According to some embodiments of the invention, the actor is analyzed to estimate at least one of an age and a physical condition.

According to some embodiments of the invention, a physical condition of an actor is associated with actions depicted in the digital media objects.

According to some embodiments of the invention, the testing for first-generation includes analyzing at least one of a size of a file, metadata associated with the file, a location of the file, and editing of an image in the file.

According to some embodiments of the invention, the metadata associated with the file includes EXIF location and/or EXIF device type data.

According to some embodiments of the invention, the system further includes rating a likelihood that an item is first generation.

According to some embodiments of the invention, the system further includes at least one of a write blocker, a forensic bridge, and a password recovery device.

### BRIEF DESCRIPTIONS OF SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the figures where:

FIG. 1 is a flow chart illustration of a method of identifying illegal content in accordance with an embodiment of the current invention;

FIG. 2 is a flow chart illustration of a method of identifying illegal content in accordance with an embodiment of the current invention;

FIG. 3 is a block diagram illustration of a system for identifying illegal content in accordance with an embodiment of the current invention;

FIG. 4 is an illustration of relationships between different materials on an electronic storage in accordance with an embodiment of the current invention;

FIG. 5 is an illustration of relationships between different materials on an electronic storage in accordance with an embodiment of the current invention; and

FIG. 6 is A flow chart illustration of a method for identifying first generation content in accordance with an embodiment of the current invention.

### DESCRIPTION OF SPECIFIC EMBODIMENTS OF THE INVENTION

The present invention, in some embodiments thereof, relates to a system and method for identifying suspicious content and illegal activity and, more particularly, but not exclusively, to a system to identify child pornography on impounded data.

### Overview

An aspect of some embodiments of the invention relates to a system that may be used, for example, by law enforcement personnel, to automatically find and filter child pornography and violent pornography in seized digital media and/or intercepted communications. Optionally, the system differentiates first-generation digital media material (e.g., material that may have been produced by the suspect himself) from other materials (e.g., second or later generation materials that the suspect received over a digital network).

For the sake of the current disclosure “first-generation digital media” refers to newly produced or recorded media (e.g., videos and/or images that the owner received from an image capturing device without the material being transmitted over an electronic network). In terms of responsibility and investigation, it may be presumed that a person holding first-generation digital media has a direct connection to the perpetrator who produced the images (an aggressor-producer pedophile). Operationally, material that was not known to law enforcement previous to its being found in an investigation of a suspect may be considered first-generation. In many cases, first-generation media was produced by the suspect himself (e.g., the suspect is an aggressor-producer pedophile).

Impounded data is sometimes searched for previously identified pornographic material (e.g., material found in the past on the Internet). Such searcher may often be based solely on a database of well-known image coding like hash functions (e.g., md5 or sha1) or specialized image coding (e.g., PhotoDna). Such a search may not identify important first-generation materials. Thus, such a system may not be well suited to identify and/or even detect aggressor-producer pedophiles. Currently identifying first-generation pedophilic material often entails analysis and identification by human investigators. Along with being extremely slow, this methodology exposes investigators to material that is often horrific and may cause trauma and psychological damage to investigators.

In some embodiments, a system in accordance with the current invention detects and/or identifies illicit content (e.g., pedophilic material) using content sensitive automated and/or computer executed methodologies (e.g., Artificial Intelligence (AI), detection feature algorithms, General Classification Features (GCF) algorithms, boosted classifier algorithms, etc.). Optionally, such methods may identify and/or filter content (e.g., images and/or text) that has been altered or manipulated. Optionally, a content-based system may detect images that may have been modified in an attempt to evade detection by other methods.

In some embodiments, the current invention relates to a system and/or method to determine a relationship between a user of data and contents of the data. For example, in the case of an illicit content such as pedophilia, a user may be an aggressor-producer and/or a collector. A collector may have knowledge and/or personal connection to aggressors and/or may only have received content anonymously and/or via third parties. In some embodiments, data will be tested for personal connections (e.g., is it first generation, is part of a personal communication, are there relationships between illicit data and personal data). For example, illicit data may be checked for first generation content indicating for example an aggressor-producer relationship and/or a personal connection to an aggressor producer. Alternatively or additionally, non-illicit first-generation data may be checked for a relationship to illicit data. For example, this may indicate that the user of the data has some personal connection to the producer of the data. For example, personal communications and/or other personal data may be checked for a relationship with illicit data. For example, relationships between data may be identified by overlaps in the data (for example, the presence of the same person and/or object and/or background in two media objects). A relationship in data may identified by overlapping idiosyncratic contents (for example, use of an unusual common expression and/or mannerism of people and/or technical production of the media). A relationship in data may be identified determining a correspondence between the data and a user (e.g., the user visited a location where the illicit data was produced, the user had communication with a person connected to the illicit data).

In some embodiments, a system in accordance with the current invention facilitates identifying the aggressor-producer pedophile and/or differentiating the aggressor-producer pedophile from the collector pedophile. For example, this may help law enforcement agencies to target the source of the problem, rather than just the collectors.

In some embodiments, the current invention is designed to work in tandem with image coding technology. For example, finding images that are not associated a database of known illicit content may be indicative of an aggressor-producer pedophile. In some embodiments, metadata such as Exchangeable image file format (EXIF) data and file size, may be used to further classify first-generation content.

In some embodiments, the current system scans data (e.g., impounded media and/or intercepted data) for illicit material (e.g., child pornography and violence). In some embodiments, the current system filters the scanned material based on content and/or classifies the material based on legal issues and/or metadata properties, such as file size, camera data, identifier data, date data, location data, time data, and/or content.

In some embodiments, the system may recognize first-generation materials. Optionally, recognition of first-generation materials may be based on, for example, excess materials, repetition, less editing (e.g., cuts in videos, repairs, etc.), grouping (for example, material may be grouped by when and where it was filmed rather than a story line), and/or physical characteristics of associated actors over multiple media objects and time. Optionally, the system may associate an actor over different characters and their physical characteristics (such as, health, age, weight, height, musculature, skin tone, facial features, identifying markings (e.g., birth marks, tattoos, scarring), etc.) over multiple media objects. Optionally, the actors' physical characteristics (e.g., such as, biometric data, health, age, weight, height, musculature, skin tone, facial features, identifying markings (e.g., birth marks, tattoos, scarring), etc.) may be associated with production data on files (e.g., camera data, identifier data, date data, location data, time data, etc.). Optionally, actors' physical characteristics (e.g., such as, biometric data, health, age, weight, height, musculature, skin tone, facial features, identifying markings (e.g., such as, biometric data, health, age, weight, height, musculature, skin tone, facial features, identifying markings (e.g., birth marks, tattoos, scarring), etc.) may be associated with content and/or actions (e.g., violence) over various media and times. The system may use multiple tests for both illegal content and first-generation material. The system may rate the material for likelihood of first-generation material and/or illegal content.

According to some embodiments, the system may rate the material for likelihood of first-generation material and/or illegal content. The ratings may be configured to facilitate quick legal action. The system may optionally recognize different image and/or video capturing devices and/or their signatures on files (e.g., from metadata about images and/or from size and/or quality of the images, etc.). The system may recognize the location of images from metadata and/or be sensitive to groupings of files on a storage device and/or common image background objects and/or common file dates. For example, images that appear to have been filmed in the same location may be grouped together and/or sequential and/or temporal connections between data may be recognized and/or reported. The investigative methodology may involve scanning for first-generation material, and then scanning for illegal content or vice versa. Multiple tests may be used to identify both illegal content and/or first-generation materials.

In forensic analysis it may be useful to separate between data that is being consumed by a suspect and data that originated on a device directly associated with the suspect. For example, when investigating illegal activity, such as child pornography, there is a significant legal and practical need to differentiate between a first set of images that were downloaded to a device over the Internet and a second set of images that were produced by a user of the device and/or produced by an agent of the owner of the device and/or produced by a person known to the owner of the device and/or possibly supplied by the owner of the device to others (e.g., to differentiate between collector-type and aggressor-type material). Particularly, first-generation images may be presumed to fall into the second set.

As used herein, according to some embodiments, where applicable and unless explicitly disclaimed as a still image, the term “image” includes a still image and/or video and/or an image in a video.

In some embodiments, the method suggests scanning a device for first-generation images. Recognition of first-generation images may be based for example, on the file size of the image and/or metadata associated with the image. Additionally, or alternatively, some embodiments of the current method suggest analyzing first-generation material separately from data acquired from other sources.

Many child pornographers and/or pedophiles are prosecuted based on materials (e.g., photographs, videos) found on seized digital media and/or intercepted communications. Therefore, there is a need to find, classify, and review the most incriminating materials as quickly as possible. Every day that a perpetrator remains at large he may do significant harm and/or escape and/or act to protect himself and his “business” from prosecution. Conventional searches can be slow-(for example, when using hash tags to find known illicit materials there may be a huge library of hash tags for known object and each file is checked against this huge library, searching a quantity of material may take weeks). Conventional searches may produce a huge amount of data that will need to be evaluated by hand (such evaluation is difficult and may be quite traumatic for the investigators/lawyers/juries/judges that are forced to perform the evaluation, and may take a long time (e.g., weeks to months)). Conventional searches may not be efficient in finding and/or recognizing first-generation materials (e.g., images that originated and/or were made by the suspect and/or his personal contacts). First generation materials (e.g., raw footage, etc.) may not have been uploaded to the Internet and/or may not yet have been recognized and assigned a hash function, and therefore may not be found when searching via comparison to a known hash function database. Additionally, image and/or hash function comparison to a database of known material to determine whether material is first-generation (e.g., using the operational definition of first-generation material as material not previously known to the law enforcement) by comparing to a database on previously known material may take a long time.

Some embodiments of the current invention relate to developed tools (e.g., based on long experience in Internet filtering using content analysis and/or Artificial Intelligence) that scans files and/or recognize pornographic materials and/or violence, etc. Optionally, tools have been developed to determine the age of subjects, etc. (e.g., used for real time Internet filtering).

In some embodiments, the system may search for, identify and/or classify first-generation materials. Optionally, the system may scan media for pornography and/or violent media and/or may filter the material based on various content issues (e.g., child pornography, possible actual harm to subjects, signs of actual brutality and/or injuries and/or disappearing actors and/or changes in actors over time from media to media, etc.). In some embodiments, the system may classify media as likely first-generation material, for example based on metadata and/or file properties (as opposed to material downloaded from the Internet), such as production dates, file histories (was it uploaded and/or downloaded, etc.) Thus, in some embodiments, the system may quickly facilitate identification of material for rapid legal action.

In some embodiments, systems of the current invention may screen content using one or more Boosted Cascade classifier algorithms selected from the group including Haar, LBP, LRD, LRP, HOG textural features, and SkinBlob Detection or any other possible detection feature different from General Classification Features (GCF) used for post filtering. According to various exemplary embodiments of the invention, one or more additional GCF may be used to improve the accuracy of the initial screening. According to various exemplary embodiments of the invention, the GCFs may include one or more of color moment, Gabor function, color histogram, skin blob geometric information, color layout, intensity edge histogram, 3 colors plane edge histogram, color structure, and scalable color. In some embodiments, each GCF may be expressed as a vector with a natural number value of 1 or 2 representing a two-class discrimination system. In some embodiments, each GCF may be expressed by two probability variables between 0 and 1. In some embodiments, a global probability vector may be used to summarize 2, 3, 4, 5, 6, 7, 8 or more GCFs. Alternatively, or additionally, in some embodiments a formula may be used to summarize 2, 3, 4, 5, 6, 7, 8 or more GCFs and/or the global probability vector.

In some embodiments, detection of illicit content may employ an object detector configured to identify one or more regions of interest (ROI) in an image file as potentially containing an object of interest (OOI). In some embodiments, detection of illicit content may employ a feature analyzer adapted to express one or more General Classification Features (GCF) of each ROI as a vector. In some embodiments, detection of illicit content may employ a decision module adapted accept or reject each ROI as containing the OOI based upon the one or more GCF vectors. In some embodiments, the object detector may employ one or more Boosted Classifier algorithms (e.g., WaldBoost, LogitBoost, AdaBoost-Gentle AdaBoost, Discrete AdaBoost, Real AdaBoost, etc.) including at least one textural feature selected from the group consisting of Haar, LBP, LRD, LRP, HOG, etc.

Alternatively, or additionally, in some embodiments the GCFs may include one or more of Gabor function, skin blob geometric and color information, intensity edge histogram, 3 colors plane edge histogram, color information, such as color histogram, color layout, color moment, color structure and scalable color. Alternatively, or additionally, in some embodiments each GCF may be expressed as a vector with a natural number value of 1 or 2 representing two class discrimination system and/or two probability variables between 0 and 1. Alternatively, or additionally, in some embodiments a global probability vector may be used to combine two or more GCFs response vectors. Alternatively, or additionally, in some embodiments a formula may be used to summarize two or more GCFs and/or the global probability vector.

Alternatively, or additionally, in some embodiments the feature analyzer may employ intensity edge histogram and color layout sequentially to identify objects. Alternatively, or additionally, in some embodiments the objects may be selected from the group consisting of faces, eyes, biometric data, etc. Alternatively, or additionally, in some embodiments the feature analyzer may employ intensity edge histogram, color structure and scalable color sequentially to identify sexual organs, e.g., breasts, etc. as objects. Alternatively, or additionally, in some embodiments the object detector may employ Skin Mask and Blob Detection to determine ROIs and geometrical information filter. Alternatively, or additionally, in some embodiments, the feature analyzer may employ intensity edge histogram, Color Layout and Color Moment. Optionally, scanning for illicit content may employ one or more of Haar, LBP, LRD, LRP, HOG, Blob Detection applied on Skin Mask. Alternatively, or additionally, in some embodiments the GCFs may include one or more of Gabor function, skin blob geometric and color information, intensity edge histogram, 3 colors plane edge histogram, color information such as color histogram, color layout, color moment, color structure and scalable color.

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

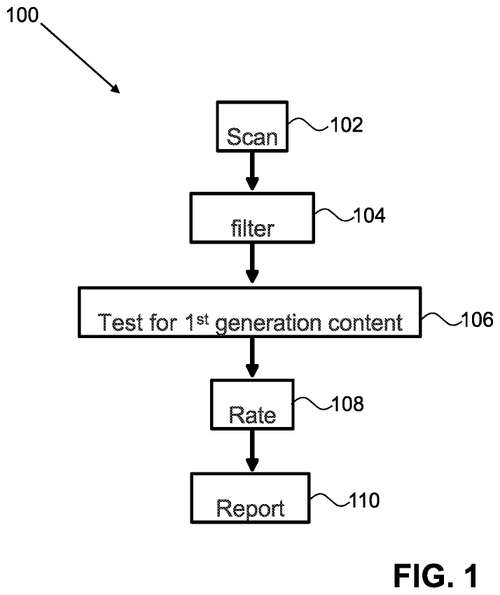

Referring now to FIG. 1, which is a flow chart illustration of a method of identifying illegal content in accordance with an embodiment of the current invention. For example, the flow chart outlines the steps involved in method 100 if the system's process of identifying and filtering child pornography and/or violent pornography.

In some embodiments, in method 100, the system first scans 102 the data for child pornography and/or violent content. The identified material is filtered 104 based on various content and/or legal issues (e.g., for example, child pornography, signs of actual brutality and/or injuries and/or disappearing actors, and/or changes in actors over time from media to media, etc.). The filtered material is tested for first-generation content 106, and classified (e.g., rated 108) for the likelihood of the media being first-generation materials based on these tests. The rating and/or test results are then reported 110 to an investigator and/or team of investigators.

In some embodiments, in method 100, the system first scans 102 the data for child pornography and/or violent content. For example, the system may use content analysis and/or artificial intelligence tools. The tools may optionally be designed to quickly identify and/or filter 104 these materials based on various legal issues. The issues may include, for example, child pornography, signs of actual brutality and/or injuries and/or disappearing actors, and/or changes in actors over time from media to media. After identifying potentially illegal materials, the system optionally tests the identified media for first-generation materials 106. This may be done, for example, by analyzing various file properties and/or metadata, such as file size, camera identifier, file location and/or production dates. The system optionally rates 108 the likelihood of the media being first-generation materials based on these tests.

In some embodiments, a suspect's data may be attached the system. For example, data may be tagged and/or the system may have storage areas tagged with information and/or results relevant to a particular investigation. Optionally, physical tags may be placed on physical media and/or data may be tagged digitally, for example with hash tags and/or pointers to storage locations etc.

In some embodiments, impounded data may be scanned for suspicious content. For example, first the data may be scanned for images including skin colors and/or pornographic material and/or for naked figures. Data identified as likely to include naked and/or pornographic content may be checked if it includes pedophilic material. Optionally, each photo and/or video may be rated 108 for example, scantily clad, naked, low risk of pedophilia, medium chance of pedophilia, and/or high chance of pedophilia. Optionally, the scanning may use first a fast coarse method to eliminate material easily recognized as non-suspect and/or successively use more resource intensive tools to narrow down the candidate data.

In some embodiments, the system may rate 108 various data objects (e.g., media files) for the level of risk of illicit activity, e.g., pedophilia. The user may optionally designate a threshold to be identified and/or classified. For example, the threshold may determine what the ratio is at each level between the false positive and the true positive. For example, “confidence value” may be defined using a SoftMax function. Images that have a combination of the models that are likely pedophilia (e.g., greater than 80% and/or 90% and/or 95% and/or 99% confidence may be defined as HIGH probability. Optionally, a model that the identified data are not highly confident that they contain the illicit content (e.g., a confidence less than 75% may include many mistakes and/or be called a low confidence illicit activity data.

In some embodiments, the scanning 102 may identify material based on content and/or other heuristic means. For example, this may find illicit material that is not on a database on known materials (e.g., a hash table). For example, rather than finding illicit material based on a data base, data on pedophilia may be used to train a machine learning system and/or contents filtering system to recognize material. Using machine learning, if there is a “first-generation” material, it may be recognized even if it is not on a database of known materials.

In some embodiments, the suspicious material may be filter 104, for example, based on the seriousness of the apparent criminal activity and/or the type of activity and/or the likelihood that such evidence will lead to successful prosecution and/or support further investigation and/or the difficulty for prosecution and/or the time for prosecution. Alternatively, or additionally, filtering 104 may be made based on the classification and/or the likelihood of material being first-generation (for example, only material likely to be first-generation may be filtered 104) and/or the material may not be filtered.

In some embodiments, a determination may be made whether material that is found is already known, e.g., by comparing to a known hash table, database, etc. Material found in the database may be treated as likely not first-generation (e.g., the suspect is part of the source of the material) and/or material that is not found on a known database may treated as likely be first-generation. For example, the found material may be compared to known illicit material, for example, a list of known illicit material. For example, the found material can be comparted to a database (e.g., hash database)—the found material may be checked against a database known pedophilia, however such a test may take a long time.

In some embodiments, the path of the original file may be used to determine first-generation material, e.g., photographs that the suspect took (in the Camera directory or the outgoing WhatsApp directory, not the incoming one), etc.

In some embodiments, technical parameters of the image may be used to determine whether it was downloaded from the Internet. Some exemplary parameters are:

Image size—an image from the internet will likely be small, for example a downloaded image may have a size of about 1.5 megabytes and/or range in size between about 1 to about 1.5 megabyte and/or between about 1.5 to about 3 megabytes. Optionally, an image larger than this is likely uploaded from a camera and/or another first-generation source. Optionally, various size cut offs may be used as an indication of the likelihood of the material being first-generation. For example, images files of a size greater than 300 Kb may be considered possibly first-generation content, and files greater than 1 Mb and/or greater than 1.5 Mb may be considered highly likely to be first-generation. A rating system may treat various levels of likelihood of being first-generation content in an algorithm to detect and/or identify illicit materials.

In some embodiments first-generation material may be identified based on metadata. For example, some parameters that are unlikely to be carried over the Internet. For example, parameters called “Exchangeable image file format (Exif) parameters” (for example, due to reasons of “Privacy and security”) are often removed before uploading material to the Internet. Optionally, the absence of such metadata may be used as a factor indicating that the material is likely from the internet and not first-generation. Optionally, the presence of such metadata may be used as a factor indicating that the material is first-generation. Examples of such metadata include Exif parameters (e.g., geolocation and/or unique ID number of the device).

Additionally, or alternatively, other factors may be used as evidence of the material being first-generation. For example: formats for images, sound, and ancillary tags used by digital cameras (including smartphones), scanners and other systems handling image and sound files recorded by digital cameras. Examples of such data include the following existing encoding formats with the addition of specific metadata tags: JPEG lossy coding for compressed image files, TIFF Rev. 6.0 (RGB or YCbCr) for uncompressed image files, and RIFF WAV for audio files (linear PCM or ITU-T G.711 u-law PCM for uncompressed audio data, and IMA-ADPCM for compressed audio data). Optionally, JPEG 2000 or GIF encoded images may not be supported. The above factors may indicate that the material was not downloaded from the Internet but came directly from a camera.

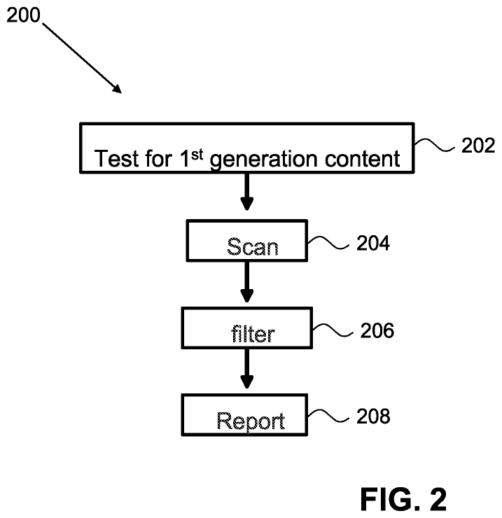

Reference is made to FIG. 2, which is a flow chart illustration of a method of identifying illegal content in accordance with an embodiment of the current invention. For example, method 200 may be used for identifying and/or filtering child pornography and/or violent pornography. Method 200 includes testing 202 for first-generation content before scanning 204, filtering 206, and reporting 208 the results thereof.

In some embodiments, testing 202 for first-generation content may be performed before scanning 204 for child pornography. For example, the system first tests 202 the digital media for first-generation materials using various tests, such as file size, metadata, and/or comparison to known data. Optionally, the system may then scan 204 the material that is suspect of being first-generation for child pornography and violent media, for example using content filtering tools. After identifying potentially illegal materials, the system may filter 206 the materials based on content and/or various legal issues, including child pornography and signs of actual harm. The system may rate the likelihood of the media containing illegal materials and/or the serious of the offenses and/or the need for quick action to protect victims and/or the likelihood of success in prosecution and/or recommended strategies based on these tests, or a combination thereof.

In some embodiments, a system receives a media for scanning, which may include either an impounded disk and/or other storage device. Optionally, the system performs a scan of the media. For example, in the scan the system may identify and classify first-generation materials. In some embodiments, the system then filters 206 the first-generation materials for illegal content, such as child pornography and violence, and/or classifies them accordingly. When illegal content is found, the system may classify the material and/or a portion thereof as the most important for quick legal action.

Additionally, or alternatively, the system may use multiple tests to rate the material for likelihood of being first-generation. The system can recognize first-generation material based on various factors, such as file size, metadata, content, and location.

In some embodiments, a factor in identifying first-generation material may include metadata. Many digital cameras and/or smartphones add metadata to images that includes information, such as the camera make and model, the date and time the image was taken, and the GPS coordinates of the location where the image was taken. This metadata can be used to determine if the image was captured by a camera or downloaded from the internet. Presence of this data may be a sign of first-generation materials. When multiple files with similar metadata are found and/or files with metadata similar to illicit content are found, the suspect may be reported as likely a source and/or possessor of first-generation materials. In some embodiments, when illicit material is found with metadata, a further search may be made for other material (even if it is not in itself illicit) having similar metadata that may be additional evidence of the suspect's connection to the illicit material.

In some embodiments, a factor in identifying first-generation material may include file properties, such as: downloaded images often have different file properties than images captured by a camera. For example, downloaded images may be in a different file format and/or have a different file size (e.g., larger) than images captured by a camera.

In some embodiments, a factor in identifying first-generation material may include a file path. When the image is stored in a folder that is commonly used to store downloaded files and/or that includes other downloaded files, such as the “Downloads folder”, it is more likely to be a downloaded image. On the other hand, if the image is stored in a folder that is commonly used to store images captured by a camera and/or stored with other original material, such as the “DCIM folder” on a smartphone, it is more likely to be an image captured by a camera.

In some embodiments, a factor in identifying first-generation material may include compression artifacts. Images that have been downloaded from the internet may have compression artifacts that are unlikely to be present in images captured by a camera. These artifacts can include pixelation, blurriness, distortion, filters, and/or various editing features (e.g., brightness, color adjustment, cropping, rotating, sharpening, etc.) or a combination thereof.

In some embodiments, the system may use recognition techniques to associate actors and their physical characteristics such as, health, age, weight, height, musculature, skin tone, facial features, identifying markings (e.g., birth marks, tattoos, scarring), etc.) with production data, content and/or actions over multiple media and times.

In some embodiments, the data may be filtered 206 based on content and/or legal issues and/or classified as to its first-generation status. Optionally, the system may track individual actors over different media files. This can be done by associating different characters and their physical characteristics (such as, health, age, weight, height, musculature, skin tone, facial features, identifying markings (e.g., birth marks, tattoos, scarring), etc.) over multiple media objects. The system may track changes in these actors (e.g., physical condition, health, age, weight, height, musculature, skin tone, facial features, identifying markings (e.g., birth marks, tattoos, scarring), etc.) and correlate it with the date of the content and/or actions in the content (e.g., after a scene with violence did the actor appear injured in later scenes and/or apparently unrelated content). This information can be useful for identifying potential victims, suspects, and/or patterns of behavior. The system may use additional tests to rate the likelihood of media containing illegal content or being first-generation materials.

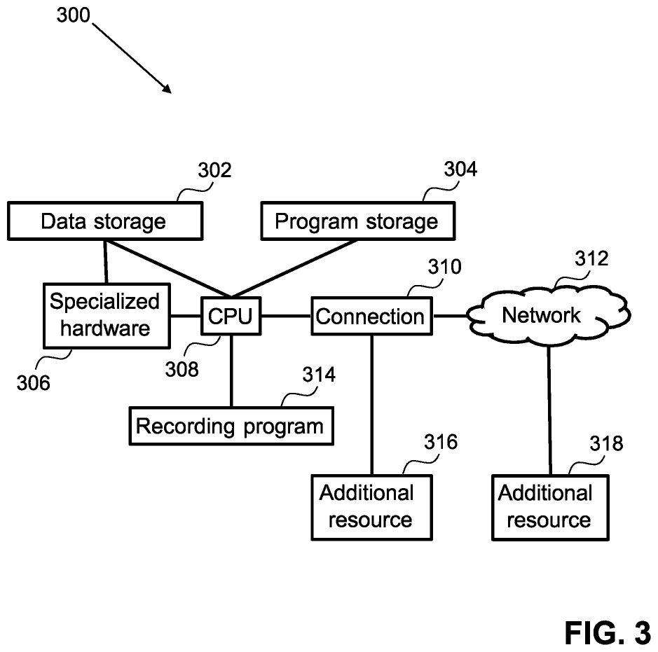

Reference is made to FIG. 3, which is a block diagram illustration of a system for identifying illegal content in accordance with an embodiment of the current invention. In some embodiments, system 300 may include a computer server and/or cluster with high processing power to analyze large amounts of data. Additionally, or alternatively, the system may include one or more large storage systems, such as network-attached storage (NAS) or storage area networks (SAN), to store the large volume of data.

System 300 includes a central processing unit (CPU) 308 including a data storage 302, program storage 304, and a recording program 314. CPU 308 may be incorporated into and/or include specialized hardware 306 (such as, one or more devices for high-speed processing, large memory, cloud computing, quantum computing, server network, large storage system, database, etc.). CPU 308 may be connected 310 to additional resources (e.g., one or more databases, trained artificial intelligence algorithms, etc.) 316, and/or a network 312 which may include and/or be linked to additional resources 318. Optionally, the connection may be a hard connection, a local area network (LAN), wi-fi, and/or connection to cloud computing.

In some embodiments the system may include a fast connection. For example, the connection may be to a network and/or directly between devices in the system. For example, the connection may include a data speed ranging between about 0.1 Gbps to about 1 Gbps and/or between about 1 Gbps to about 5 Gbps, and/or between about 5 Gbps to about 15 Gbps, and/or between about 0.1 Gbps to about 1 Gbps, and/or between about 15 Gbps to about 50 Gbps, and/or between about 50 Gbps to about 500 Gbps. For example, the connection may include a 10 Gbps Ethernet connection or faster.

In some embodiments, a system may include data storage including software routines and/or firmware routings. For example, the routines may include content filtering tools and/or routines to scan for images and videos and/or routines to filter and/or classify images and videos. Additionally, or alternatively, the routines may include forensic routines. For example, the forensic routines may analyze digital media for metadata, file histories, and/or other identifying information. In some embodiments, software may include content filtering routines, biometric, face and other identification routines, health data (e.g., from internet), statistical data, calculating routines, and any combination thereof.

In some embodiments, a system may include specialized hardware. Optionally, specialized hardware may include forensic hardware. For example, forensic hardware may include digital forensic tools. Digital forensic tools may include, for example write-blockers and/or forensic bridges. Additionally, or alternatively, some tasks may be performed with firmware and/or hardware, for example, the system may include a password recovery device, for example, Tableau TPR1 by Tableau available from the High Tech Crime Institute 1727 Coachman Plaza Drive, Suite 213 Clearwater, Florida 33759. Digital forensic tools are optionally used to securely access and analyze digital media without altering the original evidence. Additionally, or alternatively, the system may include specialized hardware, such as graphics processing units (GPUs) and/or field-programmable gate arrays (FPGAs), to accelerate image and video processing.

According to some embodiments. resources of the system (e.g., memory, processors, data that is available) may be local (e.g., part of a hard wired and/or proprietary system. Optionally, the suspect data may be processed and or uploaded to the CPU from the field (e.g., from a suspect computing device on site). Optionally, the suspect data may be processed and or uploaded to the CPU in a forensic laboratory. Alternatively, or additionally, parts of system may be connected via a public and/or private and/or secure network. The system may use network connections to access data that is pertinent to an investigation, for example, identification information, location information, weather, social media, and/or other information about people, places and/or times that can be identified in images. Optionally, operators of the system may control system functions remotely.

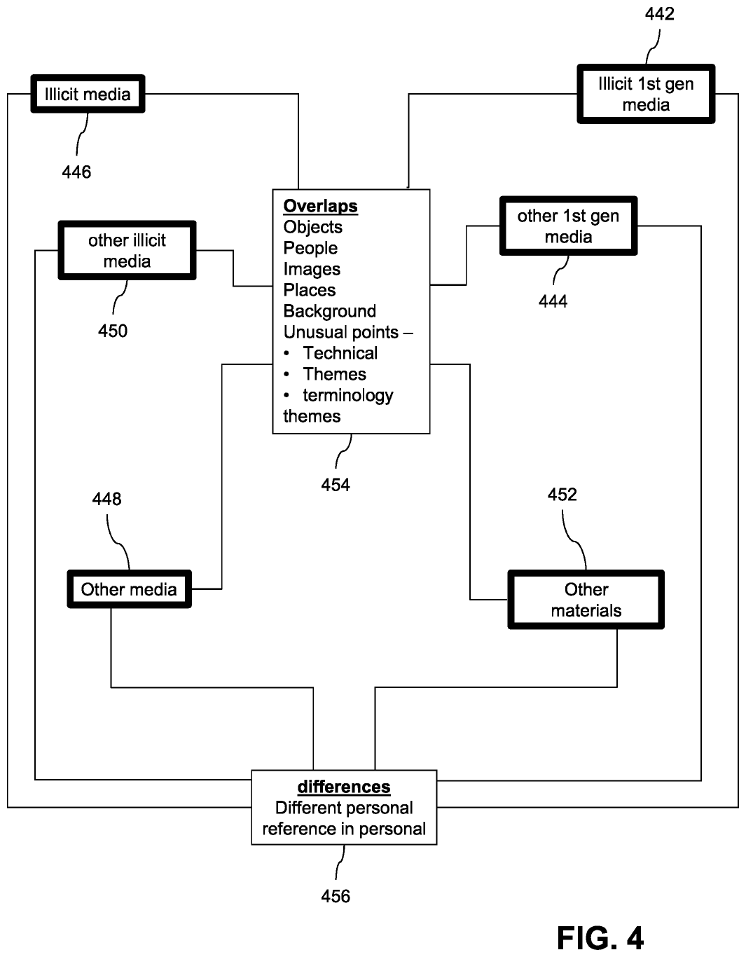

FIG. 4 is an illustration of relationships between different materials on an electronic storage in accordance with an embodiment of the current invention. In some embodiments, various types of material an electronic storage will be classified for different types of material and/or various types of content. The material will optionally be analyzed for interrelationships between the types of material and the content.

In some embodiments, digital material will be content filtered and/or classified into different content categories such as illicit material (e.g., pedophilia) and other material and/or the material will be classified according to type of material for example first generation media, other media and/or other materials (e.g., downloaded documents, local documents, personal communications etc.). For example, materials on a storage medium may be classified as illicit first generation media 442 (e.g., first generation materials that are identified by a content filter as having objectionable material e.g., pornography, violence, pedophilia), other first generation media 444 (e.g., first generation images and/or videos that on their own do not arouse objections of the content filter for objectionable content), other illicit media 446 (e.g., materials that don't appear to be first generation but are identified by a content filter as having objectionable material e.g., pornography, violence, pedophilia), other media 448 (media that does not appear to be first generation and is not identified by a content filter as having objectionable material e.g., pornography, violence, pedophilia), other illicit materials 450 (media that does not appear to be first generation but is identified by a content filter as having objectionable material e.g., pornography, violence, pedophilia) and other materials 452 (various materials on the storage media e.g., downloaded documents, local documents, personal communications etc.).

In some embodiments, the system compares the various types of material. For example, the system seeks to find overlaps 454 between the various materials. In some embodiments, people and/or objects and/or locations and/or unusual markings (e.g., a fault in a camera lens) and/or unusual mannerisms (idiosyncratic word uses, anachronistic body language, forced and/or rehearsed movements) are identified. For example, people may be identified by face recognition and/or unusual tattoos and/or characteristic actions etc. The analysis may be applied to images across categories. For example, if a same person or object is recognized in a non-first-generation illicit media 450 and also in a first-generation media 444 that otherwise would not be objectionable, then the owner of the storage media would appear to have a personal connection to the illicit media 450 production. Alternatively or additionally, if there is found non-first-generation illicit media 450 that can be geolocated to a certain time and place and other materials 452 on the storage media include orders for plane tickets and/or hotel reservations in that place then there is a connection between the owner and the making of the illicit media 450.

In some embodiments, first generation material on the storage media maybe compared to materials from outside the storage media. For example, if a known actor in pedophilic videos is found in an otherwise non-objectionable first-generation image on the storage media, this may raise suspicion of the owner of the storage media having a personal connection with the pedophilia.

In some embodiments, differences 456 between materials will tip off reporting of suspicious activity. For example, if a character is referred to in a video as one name and personal correspondence on the media refers to him with a different name this appears to link the owner not only with the video personality, but with the person in another capacity.

In general, some embodiments of the current invention material on a storage media and/or off the media are classified according their type and/or content. Some materials may involve personal connection, some materials may include illicit material. In some embodiments, by classifying both the relationship of the owner to the material (e.g., first generation, downloaded, personal material) and filtering material for illicit content an automated system can identify connections between the illicit material and the user controlling the storage media. In some embodiments, relationships are sought between materials that imply personal connections and materials that imply illicit activity. Thus, the automated system may identify connections between the user controlling the storage media and the illicit material whether the connection is in the illicit material or in relationships between the illicit material and other materials on the storage media. For example, first generation materials imply personal connections and/or text in chats may imply personal connections. Illicit personal materials and/or relationship between non-personal illicit materials and personal materials are used to connect a person to illicit activities. Classifying and/or filtering types and/or contents of materials and/or searching for interrelationships may be performed by a computer. This may potentially make identification and/or prosecution of perpetrators much more efficient and/or allow prosecution of perpetrators who otherwise would get away because the investigation would take too long and/or not cover all the different kinds of materials and relationships necessary to find and prove the case.

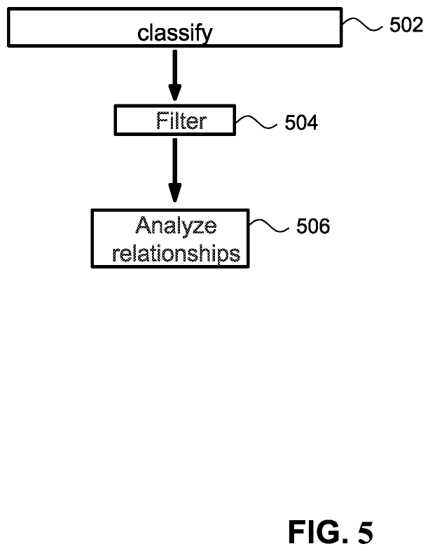

FIG. 5 is an illustration of relationships between different materials on an electronic storage in accordance with an embodiment of the current invention. In some embodiments, an electronic storage media will be scanned for different types of material, the material will be filtered for various types of content and/or the material will be analyzed for interrelationships between the types of material and the content.

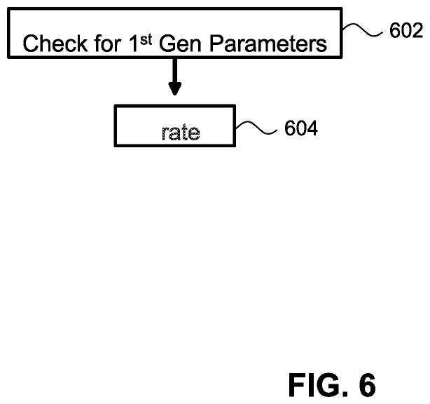

FIG. 6 is A flow chart illustration of a method for identifying first generation content in accordance with an embodiment of the current invention. For example, material may be scanned and illicit images are identified (e.g., pedophilia images are identified by content filtering that may include for example an AI routine). The identified illicit material may be tested for first generation content. Alternatively or additionally, first generation content may be identified and then scanned for illicit content.

In some embodiments, a process to identify a media (e.g., a single image and/or a video) whether it is “original creation” (first generation) or downloaded from the Internet may include checking 402 for factors that are indicatory of first generation content. For example, the system may check for the following four factors and/or additionally factors and/or a portion of the following factors.

One factor may be whether the material is already known in existing databases. New material, not found in existent databases (e.g., open databases such as NCMEC or project vic, or closed databases such as Interpol/FBI) is considered more likely to be first generation. For example, a well-known image is likely to be accessible to and/or found by many people who did not create the image. On the other hand, it is reasonable that a person having a unique image that is not known to be widely available is more likely to have a personal connection to the image source. Thus, in some embodiments, if the image is not found in known databases it may receive a point.

In some embodiments, another factor may include the size of the image. Typically, shared images over the Internet are compressed and/or reduced in size. For example, it is not typical for an image downloaded from the Internet to be larger than a threshold size (for example, over 1.5 megabytes). Thus, in some embodiments, if the image is large—it gets a point. For example, because it takes time and space to upload to the Internet—the size is often reduced—so that it works quickly (for example—many social media and/or communication applications (e.g., WhatsApp) lower the quality of shared images)

In some embodiments, another factor may include whether the image features—EXIF—position. Thus, in some embodiments, if the image includes an EXIF position—it may get a point. For example, (e.g., for reasons of privacy) many systems that upload a pictures to the Internet, delete the EXIF location. Thus, in some embodiments, if the image includes EXIF location information—it gets a point.

In some embodiments, another factor may include whether the image features—EXIF—device type. Thus, in some embodiments, if the image includes an EXIF device type—it may get a point. For example, many systems that upload a pictures to the Internet, delete the EXIF device type. Thus, in some embodiments, if the image includes EXIF device type—it gets a point.

In some embodiments, the likelihood that an item is first generation may be rated 404. For example, the above factors will give each image a point score between 0 to 4. Optionally, the user (police officer/agent) will choose a picture that was probably created by the suspect and not downloaded from the Internet. The user may choose a safety level from 1 to 4 to define as likely first generation material. For example, a file with a score of 4 (e,g., all four factors) may be rated as very likely to be first generation. For example, a file with a score of 3 (e,g., three of the four factors) may be rated as likely to be first generation. For example, a file with a score of 2 (e,g., two of the four factors) may be rated as medium likelihood to be first generation. For example, a file with a score of 1 (e,g., one of the four factors) may be rated as low likelihood to be first generation. Alternatively or additionally, the factors may be scaled (some factors be weighted more than others) and/or another way may be found to decide which materials to choose for further investigation

In some embodiments, digital material will be classified 502 into different categories which imply a relationship between the user of the storage media and the content. For example, classification may include identifying first generation content and/or identifying personal communications and/or identifying downloaded content.

In some embodiments, some or all of the material will be filtered 504 according to content. For example, material containing illicit content (e.g., violence, pedophilia) will be identified. Optionally, material not from the particular storage media may be included in the investigation. For example, known pieces of illicit content may be included.

In some embodiments, relationships will be analyzed 506 between material personally connected to the user of the storage media (e.g., first generation material, personal material) and material having particular content (e.g., elicit content). For example, relationships may include overlaps such as the same person and/or object and/or location and/or similar poses and/or similar idiosyncrasies (e.g., a fault in a camera taking a photograph, an unusual phrase, an unusual speech pattern etc. being found in two different pieces of material). For example, relationships may include changes (e.g., the same person being referred to by different names, changes in a person over time etc.) (e.g., if a person shown in violent video is found in otherwise innocuous content with a scar) may be identified as incriminating.

### GENERAL

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described herein. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, and/or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is included (for example the ranges from 1 to 2 and/or from 2 to 4 includes the combined range from 1 to 4).

It is appreciated that certain features of the invention, which are, for clarity, described in the context of separate embodiments, may be provided in combination in a single embodiment. Conversely, various features of the invention, which are, for brevity, described in the context of a single embodiment, may be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of analyzing an electronic storage media for criminal activity comprising:
classifying material according to a relationship to a user of the electronic storage media; and
filtering material to identify illicit content.

2. The method of claim 1, wherein the classifying includes differentiating between first generation content and non-first-generation content.

3. The method of claim 1, further including analyzing a relationship between an illicit material and a non-illicit material.

4. The method of claim 3, wherein said relationship includes an overlap between the illicit material and the non-illicit material.

5. The method of claim 4, wherein the overlap includes a shared person, a shared object, a shared location, a shared time, a shared sound and a shared mannerism.

6. The method of claim 4, wherein the relationship includes a difference between the illicit material and the non-illicit material.

7. A method of identifying illicit material in comprising:
scanning a digital storage media for illicit content; and
testing the illicit material for first-generation material.

8. The method of claim 7, wherein said scanning identifies pedophilia.

9. The method of claim 7, wherein said scanning includes tracking of an actor in said first-generation material.

10. The method of claim 9, wherein said actor is identified across different digital media objects.

11. The method of claim 10, wherein the actor is analyzed to estimate at least one of an age and a physical condition.

12. The method of claim 7, wherein the testing for first-generation includes analyzing at least one of a size of a file, metadata associated with the file, a location of the file, and editing of an image in the file.

13. The method of claim 12, further including rating a likelihood that an item is first generation.

14. A system for identifying illicit material comprising:
a processor;
a digital memory including digital media readable by said processor; and
a digital memory readable by said processor and including instructions for said processor to perform:
scanning the digital memory for illicit content; and
testing said illicit content for first-generation material.

15. The system of claim 14, wherein said scanning identifies pedophilia.

16. The system of claim 14, wherein said scanning includes tracking of an actor in said first-generation material.

17. The system of claim 16, wherein said actor is identified across different digital media objects.

18. The system of claim 17, wherein the actor is analyzed to estimate at least one of an age and a physical condition.

19. The system of claim 14, wherein the testing for first-generation includes analyzing at least one of a size of a file, EXIF location, EXIF device type data, a location of the file, and editing of an image in the file.

20. The system of claim 14, further comprising at least one of a write blocker, a forensic bridge, and a password recovery device.
